(19) United States
(12) Patent Application Publication
(10) Pub. No.: US 2026/0066551 A1
(43) Pub. Date: Mar. 5, 2026

(54) ADDITIVELY MANUFACTURED ANTENNA WITH COLLOCATED ELECTRONICS

(71) Applicant: BAE Systems Information and Electronic Systems Integration Inc., Nashua, NH (US)

(72) Inventor: Alexander D. Johnson, Woburn, MA (US)

(73) Assignee: BAE Systems Information and Electronic Systems Integration Inc, Nashua, NH (US)

(21) Appl. No.: 18/816,760

(22) Filed: Aug. 27, 2024

(51) Int. Cl. H01Q 21/06; H01Q 1/48

(52) U.S. Cl. CPC H01Q 21/062; H01Q 1/48

(57) ABSTRACT

An antenna device includes a substrate, a ground plane located adjacent to the substrate, an antenna assembly located adjacent to the ground plane, and an electronic circuit. The ground plane has a cavity at least partially adjacent to the substrate. The electronic circuit is collocated in the cavity and between the ground plane and the substrate. The antenna device includes at least one channel extending through the ground plane from the antenna assembly to the substrate. At least one feed line extends through the at least one channel from the antenna assembly to the substrate. The antenna device includes a first pad on the substrate, a second pad on the substrate, and a conductive trace electrically coupled to the first pad and the second pad. The at least one feed line is electrically coupled to the first pad and the electronic circuit is electrically coupled to the second pad.

### FIELD OF DISCLOSURE

The present disclosure relates to antennas, and more particularly, to an additively manufactured antenna with collocated electronics.

### BACKGROUND

An aperture antenna is a type of antenna that emits electromagnetic (EM) waves through an aperture. The aperture is typically considered to include a portion of a surface of the antenna through which a majority of the EM waves are transmitted or received. Aperture antennas can be arranged in arrays to provide wideband and ultra-wideband (UWB) operations, such as in conjunction with radar and tracking systems, high data rate communication links, and multi-waveform, multi-function front end systems. The antenna is connected to electronic components via one or more feed lines or other connections, which conduct signals to and from the antenna.

### BRIEF DESCRIPTION OF THE DRAWINGS

FIG. 1 is a schematic diagram of a tightly coupled dipole array (“TCDA”), in accordance with an embodiment of the present disclosure.

FIG. 2 is another schematic diagram of the TCDA of FIG. 1, in accordance with an example of the present disclosure.

FIGS. 3A and 3B are cross-sectional views of an antenna device, in accordance with an example of the present disclosure.

FIG. 3C is a cross-sectional view of an array of the antenna devices of FIGS. 3A and 3B.

FIG. 3D is a top view of an array of the antenna devices of FIGS. 3A and 3B.

FIGS. 4A-B are top isometric perspective views of a modular antenna that can be used in the antenna device of FIGS. 3A and 3B, according to an example of the present disclosure.

FIGS. 5A-F are top isometric perspective views of various structures during several stages of fabrication of the modular antenna of FIGS. 4A-B, in accordance with an example of the present disclosure.

Although the following detailed description will proceed with reference being made to illustrative examples, many alternatives, modifications, and variations thereof will be apparent in light of this disclosure.

### DETAILED DESCRIPTION

In accordance with an example of the present disclosure, an antenna device includes a substrate, a ground plane located adjacent to the substrate, an antenna assembly located adjacent to the ground plane, and an electronic circuit. The ground plane has a cavity at least partially adjacent to the substrate. The electronic circuit is collocated in the cavity and between the ground plane and the substrate. In some examples, the antenna device includes at least one channel extending through the ground plane from the antenna assembly to the substrate. At least one feed line extends through the at least one channel from the antenna assembly to the substrate. In some examples, the antenna device includes a first pad on the substrate, a second pad on the substrate, and a conductive trace electrically coupled to the first pad and the second pad. The at least one feed line is electrically coupled to the first pad and the electronic circuit is electrically coupled to the second pad. In some examples, the antenna device includes an integral element additively manufactured into a single continuous piece of material as a unitary structural component, where the integral element includes the substrate, the ground plane with the cavity, and the antenna assembly.

### Overview

Certain multifunction missions require multiband or wideband aperture antennas in front of the mission payloads. For example, stacked patch antennas, waveguides, and slot array antennas can be used for low bandwidth operations (e.g., less than about 5:1 bandwidth ratio). In another example, a dipole antenna, and more specifically, a tightly-coupled dipole array (TCDA) antenna, can be used for wideband or ultra-wideband (UWB) operation and has a wide field of view. TCDA designs, and more generally aperture antennas, that (a) locate the antenna on the top side of a substrate (e.g., a circuit board) and the electronics on the back side of the substrate, or (b) utilize connectors to couple the antenna to the electronics, can be problematic. For instance, for substrate-mounted components, all signals to and from the antenna pass through the depth (thickness) of the substrate, which may result in significant unwanted path loss, particularly at millimeter wave (mmW) bands between 30 and 300 GHz. For connectorized components, cost and/or size can significantly constrain system design, particularly at mmW bands where connector parts are expensive and bulky (e.g., the connectors can cause the design to exceed system volume specifications). Therefore, non-trivial challenges remain with respect to certain antenna designs.

### Example Dipole Antenna

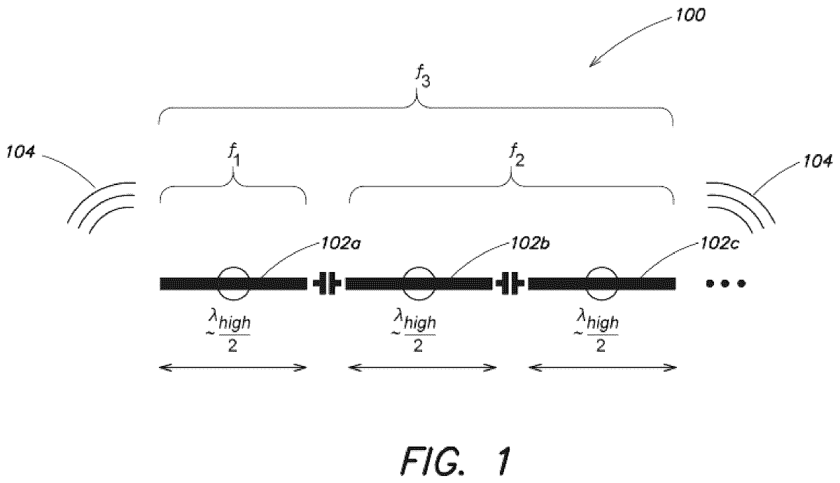

FIG. 1 is a schematic diagram of a TCDA 100, in accordance with an embodiment of the present disclosure. The TCDA 100 includes multiple half wave dipole antennas 102a, 102b, 102c, etc. Each dipole antenna 102a, 102b, 102c, can radiate or receive a signal 104 at a frequency of approximately

$$\frac{{λ}_{1}}{2} , \frac{{λ}_{2}}{2} , and \frac{{λ}_{3}}{2} ,$$

respectively. An individual dipole antenna, such as dipole antenna 102a, radiates or receives a signal at a frequency f₁. The dipole antennas 102a, 102b, 102c can be located or arrayed adjacent to each other to radiate or receive signals at frequencies f₂, f₃, etc., such as shown in FIG. 1. Such an arrangement approximates a flat current distribution across all of the dipole antennas 102a, 102b, 102c.

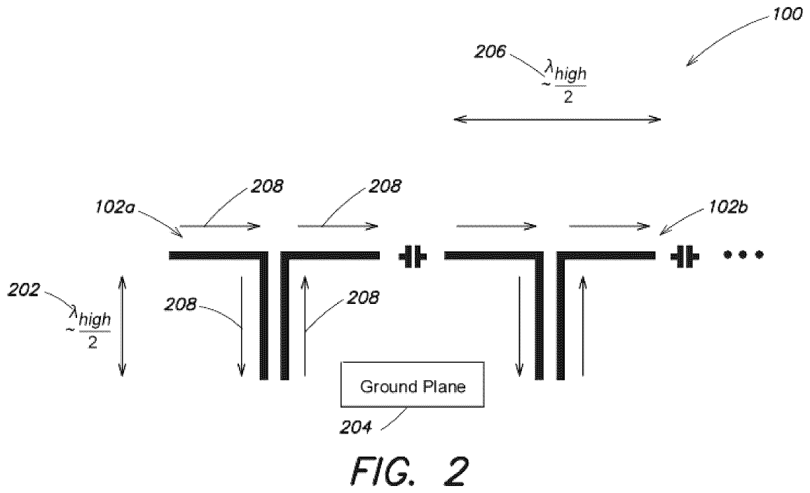

FIG. 2 is another schematic diagram of the TCDA 100 of FIG. 1, in accordance with an example of the present disclosure. The upper cutoff frequency of the TCDA 100 is established by the height 202 of the dipole elements above a ground plane 204 and a pitch (width) 206 of each of the antennas 102a, 102b. The lower cutoff frequency can be extended by coupling each of the antennas 102a, 102b and through the use of lower dielectrics in the substrate.

Antennas can be balanced or unbalanced. Some TCDAs have wideband, single-ended (unbalanced) feeds. A single-ended feed antenna is considered unbalanced because the feed signal is not symmetrical about the point at which the feed meets the conductive element(s) of the antenna that radiate or absorb EM power. For example, in a dipole arrangement, one dipole arm is energized by the signal while the other dipole arm is shorted to a ground potential. By contrast, a balanced feed antenna has complementary signals 208 in the adjacent conductive elements, such as shown in FIG. 2.

TCDAs provide certain benefits in certain applications. For example, high bandwidth TCDAs enable the antenna to perform several functions (e.g., transmit and receive several signals across a wide range of frequencies) at a single aperture. To achieve these functions efficiently, the antenna should be designed to reduce losses incurred by common mode resonances when the antenna is driven at the power levels associated with those functions. Thus, there is a need for an antenna that is easily scalable and has a wide or ultra-wide bandwidth without incurring increased losses. Examples of the present disclosure provide an antenna device that permits differential (two balanced or complementary) signals to be fed into the antenna from electronics mounted on the same side of the substrate as the antenna and the ground plane.

Additively Manufactured Antenna with Collocated Active Electronics

In accordance with an example of the present disclosure, an additively manufactured dipole array with collocated active electronics is disclosed. The antenna and electronics are collocated on the same side (e.g., the top side) of a substrate. The ground plane is fabricated with a cavity (also referred to as a skylined ground plane) within which the electronics are located. A package including the antenna (e.g., an aperture antenna), the ground plane, the electronics, and the antenna feed lines between the antenna and the electronics is constructed using additive manufacturing. This arrangement of antenna and electronics on the same side of the substrate is in contrast to designs where the antenna and the electronics are mounted on opposite sides of a substrate or are coupled using connectors. Collocation of the components on the same side of the substrate eliminates the need for board interconnects, thus reducing cost and size, particularly at millimeter wave frequencies where connectors (e.g., sub-miniature push-on micro or SMPM connectors) are expensive and where channel counts are high (e.g., >64 channels).

The skylined ground plane of the antenna provides a thermal heat sink for the active electronics and as well as signal isolation between the antenna and electronics. Additionally, in some examples, the close packaging between the electronics and the flared AM coaxial feed lines improves system performance. Without top-side collocation, the alternative of routing the feed lines through the substrate creates significant path losses, which can be untenable for practical uses at millimeter wave frequencies. Additionally, additive manufacturing provides a device that has lower weight, lower recurring cost, and lower production cost than dipoles arrays fabricated as printed circuit boards (PCB). Further, according to some embodiments, the additively manufactured antenna can be the primary radiator, and can also be utilized as a structural mechanical member for stress and load bearing.

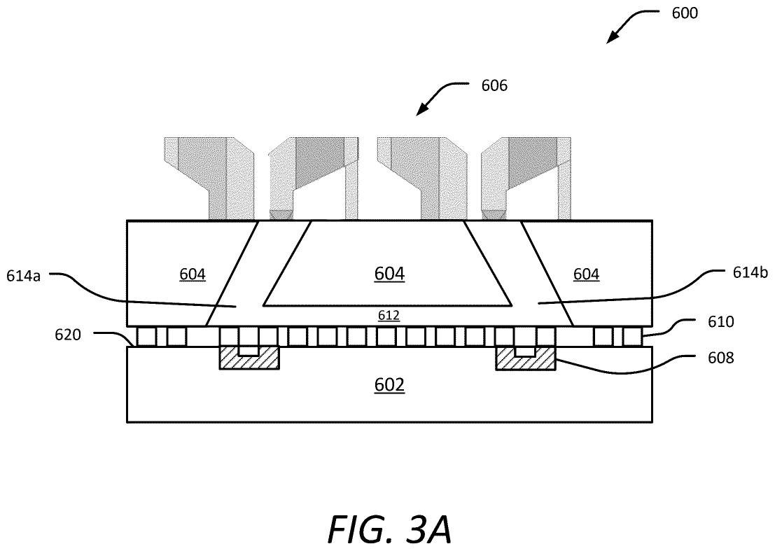

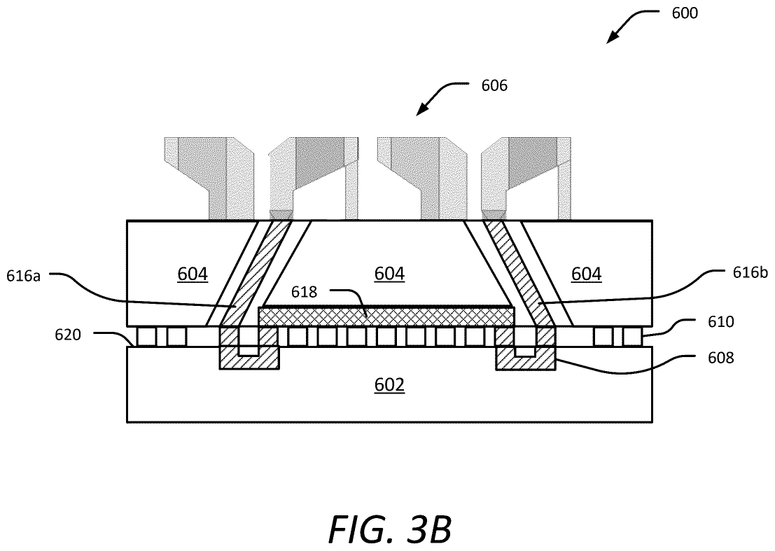

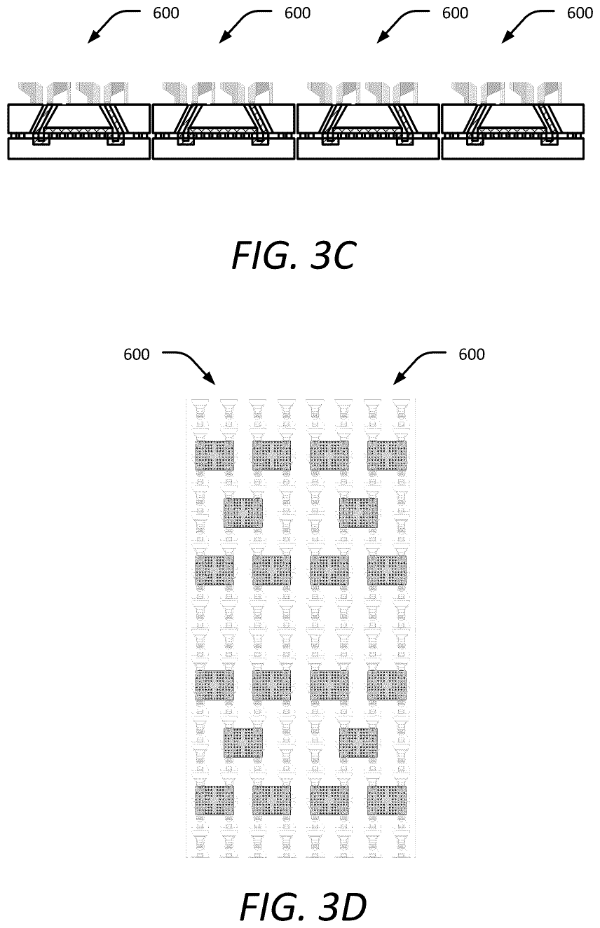

FIGS. 3A and 3B are cross-sectional views of an antenna device 600, in accordance with an example of the present disclosure. Referring first to FIG. 3A, the antenna device 600 includes a substrate 602, a ground plane 604, and an antenna assembly 606 or other type of radiator, such as an aperture antenna. The substrate 602 can include, for example, a printed circuit board or other non-conductive material with one or more conductive traces 608 and one or more conductive pads 610 that provide electrical interconnections between various components of the antenna device 600. As can be seen in FIG. 3A, the ground plane 604 includes a cavity 612 at least partially adjacent to the substrate 602. In some examples, the cavity 612 can include or otherwise be adjacent to one or more channels 614a, 614b extending through the ground plane 604 from the antenna assembly 606 to the substrate 602.

The antenna assembly 606 is located adjacent to the ground plane 604 such that the ground plane 604 is located between the antenna assembly 606 and the substrate 602. The antenna assembly 606 can include any type of additively manufactured antenna structure, such as a dipole (e.g., TCDA) antenna, a Vivaldi antenna, an inverted hat antenna, a patch antenna, a monopole antenna, an aperture antenna, and/or other antenna structure that can be located on the ground plane 604.

Referring next to FIG. 3B, the antenna device 600 includes electronics 618 or a beamformer for transmitting and/or receiving signals via the antenna assembly 606. The electronics 618 are collocated with the antenna assembly 606 on or adjacent to the same side of the substrate 602 (e.g., a top side 620 of the substrate 602). In this example, feed lines 616a, 616b extend from the antenna assembly 606 through the channels 614a, 614b to respective pads 610 on the substrate 602. The feed lines 616a, 616b are electrically coupled to the electronics 618 via one or more of the conductive traces 608 and the pads 610, such as shown in FIG. 3B.

All or portions of the antenna device 600 can be fabricated using an additive manufacturing process. The additive manufacturing process is one in which the various components of the antenna device 600 (e.g., the substrate 602, the ground plane 604, the antenna assembly 606, the conductive traces 608, the pads 610, the conductive the cavity 612, the channels 614a, 614b, the feed lines 616a, 616b, and/or the electronics 618) are fabricated by the successive addition of material (e.g., via a three-dimensional printing or other deposition process). Such a process facilitates fabrication of complex three-dimensional structures. For example, the channels 614a, 614b and the feed lines 616a, 616b can be formed to avoid obstacles, such as the electronics 618 or other integrated components, by building these features diagonally as depicted in FIGS. 3A and 3B or by using other suitable geometries that enable the antenna assembly 606 and the electronics 618 to be tightly packaged, which reduces pass losses relative to designs where the antenna and the electronics are not collocated on the same side of the substrate.

The antenna device 600, or portions thereof, can be additively manufactured as an integral element. For example, the antenna device 600 can include an integral element additively manufactured into a single continuous piece of material as a unitary structural component. The integral element can include any combination of the substrate 602, the ground plane 604 with the cavity 612 and the channels 614a, 614b, the feed lines 616a, 616b, the antenna assembly 606, the conductive traces 608, the pads 610, and the electronics 618.

In an example, the thermal mass of the antenna assembly 606 can act as a heat sink to the electronics 618 via the ground plane 604. In another example, a liquid can be forced through the channels 614a, 614b to provide cooling of the electronics 618.

The antenna device 600 can be arrayed, such as shown in FIG. 3C, which is a cross-sectional view of an array of the antenna devices 600, and FIG. 3D, which is a top view of an array of the antenna devices 600.

### Example Antenna Assembly

The following description is of an example of the antenna assembly 606 of the antenna device 600 in which the antenna assembly 606 includes a type of TCDA. It will be understood that the antenna assembly 606 can include other types of additively manufactured antennas, such as discussed above.

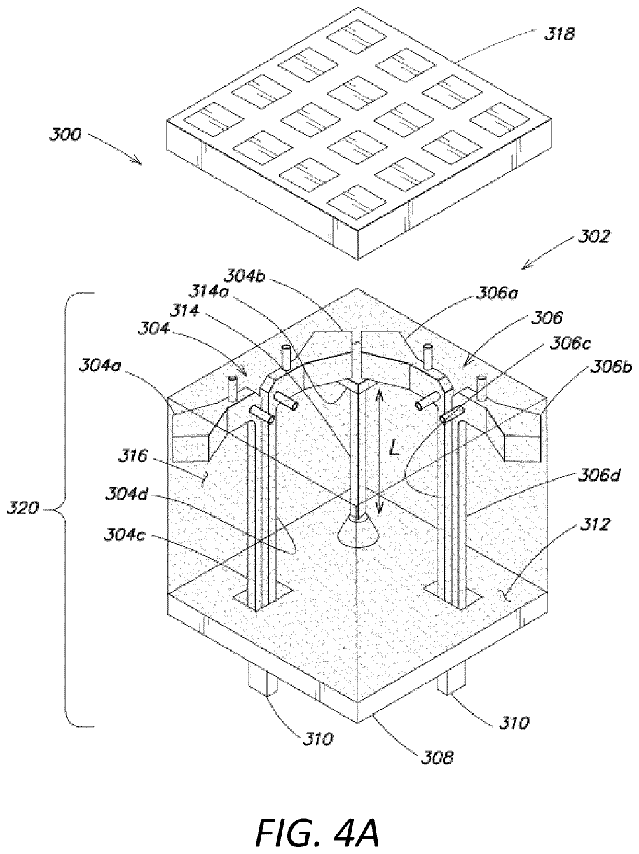

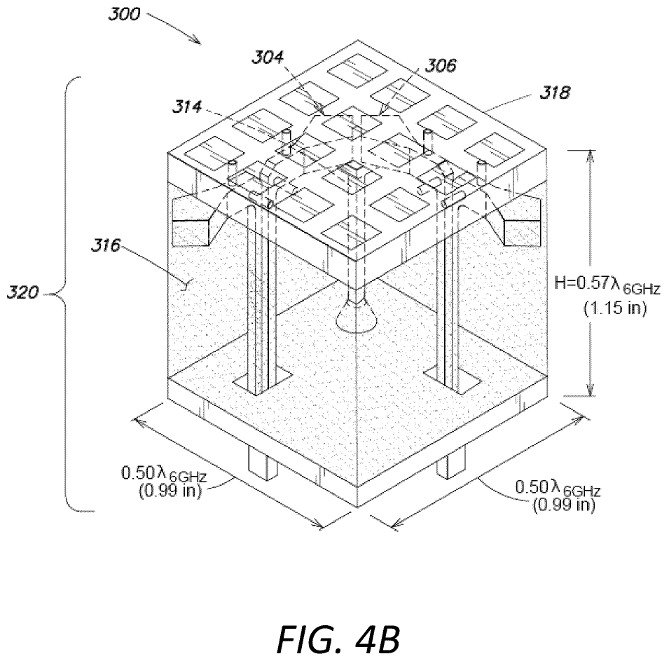

FIGS. 4A-B are top isometric perspective views of a modular antenna 300, according to an example of the present disclosure. The antenna 300 includes a 1×1 unit cell 302. The antenna 300 can, in some examples, include multiple unit cells arrayed together, such as 3×3, 6×6, etc., where each unit cell is similar to the 1×1 unit cell 302 shown in FIGS. 4A-B. In any event, the antenna 300 includes one or more 1×1 unit cells 302.

The unit cell 302 includes a first antenna element 304, a second antenna element 306, a ground plane 308, and at least one balanced antenna feed 310. The at least one balanced antenna feed 310 is configured to receive a differential (balanced) signal. Each antenna element 304, 306 includes a first conductive dipole arm 304a, 306a and a second conductive dipole arm 304b, 306b. The first conductive dipole arm 304a, 306a and the second conductive dipole arm 304b, 306b are each in planar alignment with a surface 312 of the ground plane 308. In some examples, the first conductive dipole arm 304a, 306a is a mirror image of the second conductive dipole arm 304b, 306b about a longitudinal axis extending perpendicular to the surface 312 of the ground plane 308, such that the first conductive dipole arm 304a, 306a is adjacent to the second conductive dipole arm 304b, 306b. Each antenna element 304, 306 further includes a first feedline 304c, 306c in electrical communication with the first conductive dipole arm 304a, 306a and the balanced antenna feed 310, and a second feedline 304d, 306d in electrical communication with the second conductive dipole arm 304b, 306b and the balanced antenna feed 310.

The unit cell 302 further includes a conductive wall (“H-wall”) 314 in electrical communication with the ground plane 308. The H-wall 314 has an end 314a adjacent to, and physically separate from, the second conductive dipole arm 304b of the first antenna element 304 and the first conductive dipole arm 306a of the second antenna element 306. An axial length/of the H-wall 314 is orthogonal to the ground plane 308. In other words, the H-wall 314 extends orthogonally from the ground plane 308 toward the second conductive dipole arm 304b of the first antenna element 304 and the first conductive dipole arm 306a of the second antenna element 306. The H-wall 314 does not physically contact the first or second antenna elements 304, 306. Rather, the H-wall 314 disrupts the common mode resonances (e.g., the coupled signal between adjacent unit cells 102) that would otherwise cause feed line radiation/coupling and reduce antenna efficiency. As a result, the H-wall 314 enables efficient radiation from the first and second conductive dipole arms 304a, 304b, 306a, 306b without added losses such that a bandwidth ratio of the antenna can reach 10:1 (e.g., between approximately 2-20 GHz) for balanced operation while using a differential feed and without a balun or other components for mitigating the common mode resonances.

In some examples, the unit cell 302 further includes at least one non-conductive structural support 316 between the ground plane 308 and the first feedline 304c, 306c, the second feedline 304d, 306d, or both feedlines 304c, 306c, 304d, 306d of the first and second antenna elements 304, 306, respectively. In some examples, the non-conductive structural support 316 includes a dielectric foam or resin surrounding the antenna elements 304 and 306. The non-conductive structural support 316 provides mechanical stability for the first antenna element 304 and/or the second antenna element 306 and can also include sacrificial features that can be removed during fabrication of the unit cell 302, such as during an additive manufacturing process where components of the unit cell 302 (e.g., the ground plane 308, the feedlines 304c, 304d, 306c, 306d, and the dipole arms 304a, 304b, 306a, 306b) are fabricated by the successive addition of material (e.g., via a three-dimensional printing or other deposition process).

In some examples, the first conductive dipole arms 304a, 306a are linearly polarized with respect to a first plane of polarization (e.g., V-pol), and the second conductive dipole arms 304b, 306b are linearly polarized with respect to a second plane of polarization (e.g., H-pol), where the first plane of polarization is orthogonal to the second plane of polarization.

In operation, a signal, such as an analog RF signal, can propagate between the first conductive dipole arms 304a, 306a and the balanced antenna feed 310 via the first feedline 304c, 306c. The signal can further propagate between the second conductive dipole arms 304b, 306b and the balanced antenna feed 310 via the second feedline 304d, 306d. The balanced antenna feed 310 can include a positive terminal and a negative terminal coupled to the first feedline 304c, 306c and the second feedline 304d, 306d, respectively, or vice versa. In some examples, a signal at the positive terminal is 180 degrees out-of-phase with a signal at the negative terminal (i.e., balanced or complementary signals).

In some examples, the unit cell 302, or an array of unit cells 302, is covered by a radome 318 or another overlay material. The radome 318 can include dielectric or other impedance matching materials to provide physical protection and temperature resilience for the modular antenna 300, and/or to increase power transfer and reduce signal reflection into and out of the modular antenna 300.

Referring to FIG. 4B, the dimensions of the unit cell 302, in accordance with an example for a 6 GHz application, can be approximately 0.99 inches wide by 0.99 inches deep by 1.15 inches high, or approximately 0.50λ (wavelength of signal) by 0.50λ by 0.57λ.

### Modular Antenna Array Fabrication

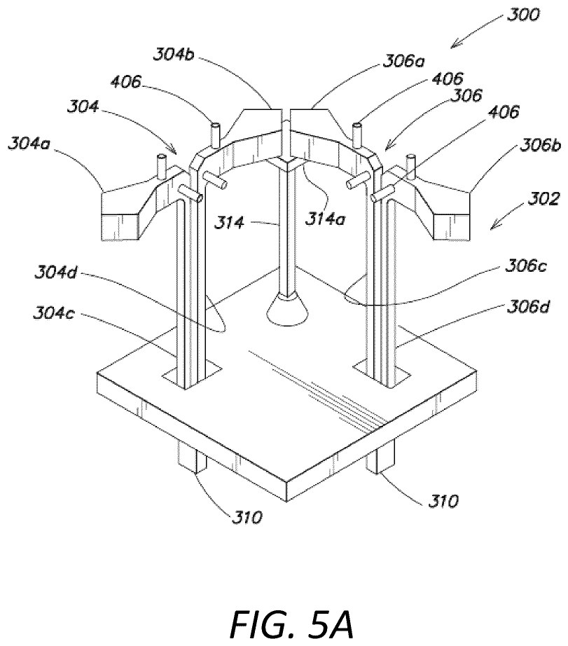

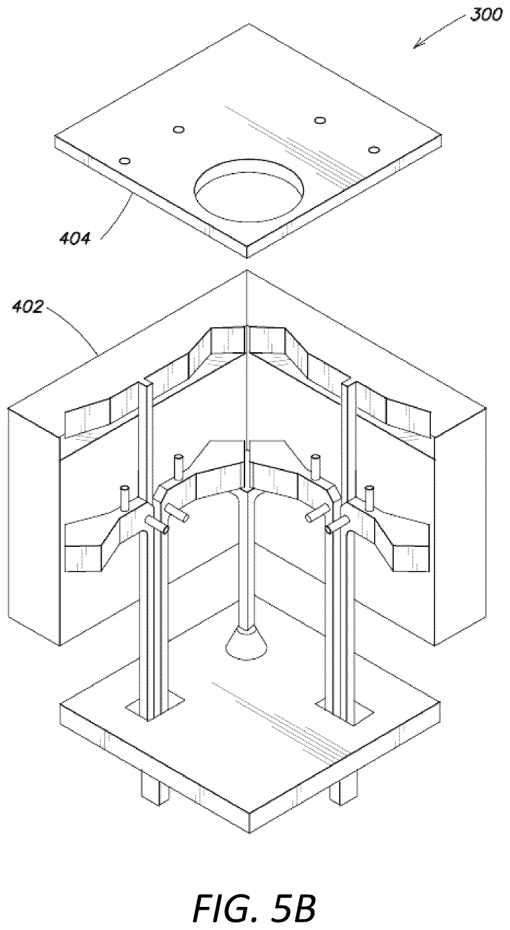

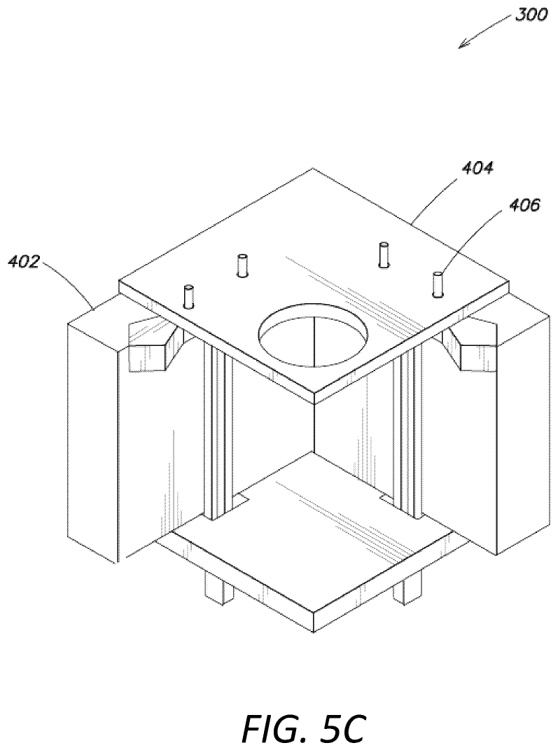

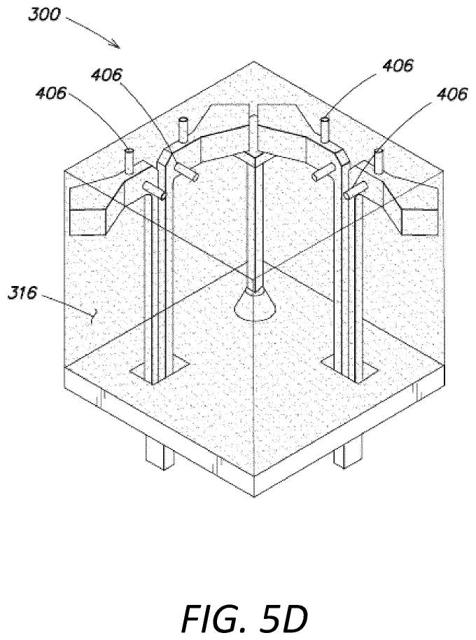

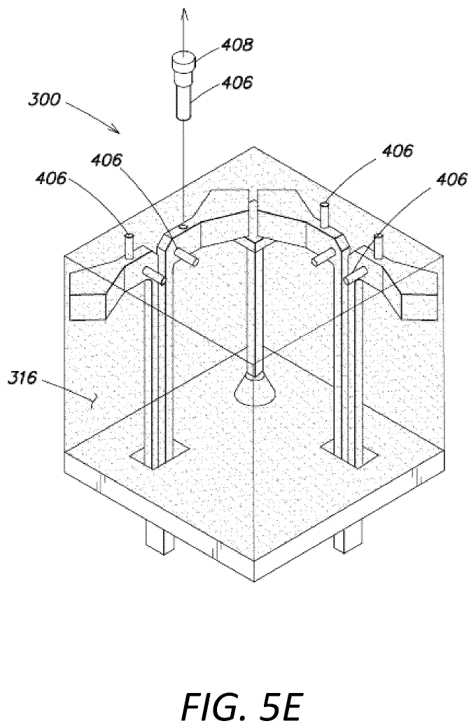

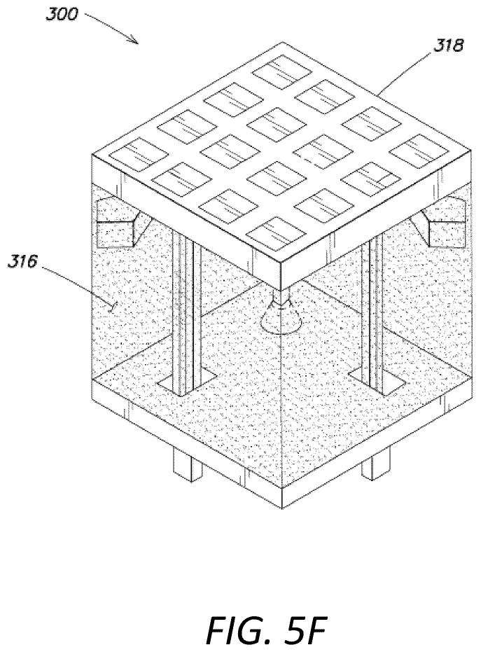

FIGS. 5A-F are top isometric perspective views of various structures during several stages of fabrication of the modular antenna 300 of FIG. 4A, in accordance with an example of the present disclosure. In general, the modular antenna 300, including one or more unit cells 302 or portions thereof, is printed or otherwise fabricated using additive manufacturing techniques. It will be understood that any number of the unit cells 302 can be fabricated in the disclosed manner, for example, as component arrays (i.e., a single unit cell 302), blocks of sub-arrays (i.e., multiple adjacent unit cells 302), or complete arrays of the unit cells 302.

The modular antenna 300 and certain other structural or sacrificial components are fabricated by additively depositing or printing material to form the various structures of the antenna, such that the product is formed from a single piece of continuous material, also referred to as an integral element 320. The integral element includes, for example, the first antenna element 304, the second antenna element 306, and the H-wall 314. In some examples, the material is at least partially electrically conductive (e.g., it is all metal or at least partially metal). In some other examples, the material is at least partially non-conductive and at least partially plated with another conductive material (e.g., a metal plating).

In some examples, a low dielectric foam or resin 316 is added to voids around the additively fabricated material of the antenna components. The foam or resin 316 provides shock and vibration mitigation or other mechanical support of the antenna components, such as the first conductive dipole arm 304a, 306a, the second conductive dipole arm 304b, 306b, the first feedline 304c, 306c, and/or the second feedline 304d, 306d. In some examples, a perimeter caul plate 402 and a perforated top plate 404 can be placed around at least a portion of the modular antenna 300 to contain the foam or resin 316 during fabrication and prior to baking or setting the foam or resin into a semi-solid state.

In some examples, such as shown in FIGS. 5A-D, one or more mechanical alignment structures 406 are fabricated in conjunction with one or more antenna components, including, for example, the first conductive dipole arm 304a, 306a, the second conductive dipole arm 304b, 306b, the first feedline 304c, 306c, and the second feedline 304d, 306d. The alignment structures 406 align the top plate 404 with the first conductive dipole arm 304a, 306a, the second conductive dipole arm 304b, 306b, prior to baking or otherwise setting the foam or resin 316. Once set, at least a portion of the foam or resin 316 provides structural support for the first conductive dipole arm 304a, 306a, the second conductive dipole arm 304b, 306b. Other portions of the foam or resin 316 and any mechanical alignment structures 406 not needed for structural support can then be machined or otherwise removed, such as shown at 408 in FIG. 5E. In some examples, a superstrate, such as the radome 318, or other overlay material can be attached to the modular antenna 300, such as shown in FIG. 5F.

### Further Example Examples

The following examples pertain to further examples, from which numerous permutations and configurations will be apparent.

Example 1 provides an antenna device comprising a substrate; a ground plane located adjacent to the substrate, the ground plane having a cavity at least partially adjacent to the substrate; an antenna assembly located adjacent to the ground plane; and an electronic circuit collocated in the cavity and between the ground plane and the substrate.

Example 2 includes the subject matter of Example 1, further comprising at least one channel extending through the ground plane from the antenna assembly to the substrate.

Example 3 includes the subject matter of Example 2, further comprising at least one feed line extending through the at least one channel from the antenna assembly to the substrate.

Example 4 includes the subject matter of Example 3, further comprising a first pad on the substrate, a second pad on the substrate, and a conductive trace electrically coupled to the first pad and the second pad.

Example 5 includes the subject matter of Example 4, wherein the at least one feed line is electrically coupled to the first pad and the electronic circuit is electrically coupled to the second pad.

Example 6 includes the subject matter of any one of Examples 1-5, wherein the antenna assembly includes one of a dipole antenna, a Vivaldi antenna, an inverted hat antenna, a patch antenna, and a monopole antenna.

Example 7 includes the subject matter of any one of Examples 1-6, further comprising an integral element additively manufactured into a single continuous piece of material as a unitary structural component, the integral element including the substrate, the ground plane with the cavity, and the antenna assembly.

Example 8 includes the subject matter of any one of Examples 1-7, wherein the antenna assembly comprises a first conductive dipole arm in planar alignment with a surface of the ground plane, a second conductive dipole arm in planar alignment with the surface of the ground plane and adjacent to the first conductive dipole arm, a first feedline in electrical communication with the electronic circuit, and a second feedline in electrical communication with the electronic circuit.

Example 9 provides an antenna device comprising an integral element additively manufactured into a single continuous piece of material as a unitary structural component, the integral element including a substrate; a ground plane located adjacent to the substrate, the ground plane having a cavity at least partially adjacent to the substrate; and an antenna assembly located adjacent to the ground plane; and an electronic circuit collocated in the cavity and between the ground plane and the substrate.

Example 10 includes the subject matter of Example 9, further comprising at least one channel extending through the ground plane from the antenna assembly to the substrate.

Example 11 includes the subject matter of Example 10, wherein the integral element includes at least one feed line extending through the at least one channel from the antenna assembly to the substrate.

Example 12 includes the subject matter of Example 11, wherein the integral element includes a first pad on the substrate, a second pad on the substrate, and a conductive trace electrically coupled to the first pad and the second pad.

Example 13 includes the subject matter of Example 12, wherein the at least one feed line is electrically coupled to the first pad and the electronic circuit is electrically coupled to the second pad.

Example 14 includes the subject matter of any one of Examples 9-13, wherein the antenna assembly includes one of a dipole antenna, a Vivaldi antenna, an inverted hat antenna, a patch antenna, and a monopole antenna.

Example 15 provides a method of fabricating an antenna device, the method comprising providing an integral element additively manufactured into a single continuous piece of material as a unitary structural component, the integral element including a substrate; a ground plane located adjacent to the substrate, the ground plane having a cavity at least partially adjacent to the substrate; and an antenna assembly located adjacent to the ground plane; and providing an electronic circuit collocated in the cavity and between the ground plane and the substrate.

Example 16 includes the subject matter of Example 15, further comprising providing at least one channel extending through the ground plane from the antenna assembly to the substrate.

Example 17 includes the subject matter of Example 16, further comprising providing at least one feed line extending through the at least one channel from the antenna assembly to the substrate.

Example 18 includes the subject matter of Example 17, further comprising providing a first pad on the substrate, a second pad on the substrate, and a conductive trace electrically coupled to the first pad and the second pad.

Example 19 includes the subject matter of Example 18, wherein the at least one feed line is electrically coupled to the first pad and the electronic circuit is electrically coupled to the second pad.

Example 20 includes the subject matter of any one of Examples 15-19, wherein the antenna assembly includes one of a dipole antenna, a Vivaldi antenna, an inverted hat antenna, a patch antenna, and a monopole antenna.

Numerous specific details have been set forth herein to provide a thorough understanding of the examples. It will be understood, however, that other examples may be practiced without these specific details, or otherwise with a different set of details. It will be further appreciated that the specific structural and functional details disclosed herein are representative of examples and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims. Furthermore, examples described herein may include other elements and components not specifically described, such as electrical connections, signal transmitters and receivers, processors, or other suitable components for operation of the modular antenna.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and examples have been described herein. The features, aspects, and examples are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. An antenna device comprising:
a substrate;
a ground plane located adjacent to the substrate, the ground plane having a cavity at least partially adjacent to the substrate;
an antenna assembly located adjacent to the ground plane; and
an electronic circuit collocated in the cavity and between the ground plane and the substrate.

2. The antenna device of claim 1, further comprising at least one channel extending through the ground plane from the antenna assembly to the substrate.

3. The antenna device of claim 2, further comprising at least one feed line extending through the at least one channel from the antenna assembly to the substrate.

4. The antenna device of claim 3, further comprising a first pad on the substrate, a second pad on the substrate, and a conductive trace electrically coupled to the first pad and the second pad.

5. The antenna device of claim 4, wherein the at least one feed line is electrically coupled to the first pad and the electronic circuit is electrically coupled to the second pad.

6. The antenna device of claim 1, wherein the antenna assembly includes one of a dipole antenna, a Vivaldi antenna, an inverted hat antenna, a patch antenna, and a monopole antenna.

7. The antenna device of claim 1, further comprising an integral element additively manufactured into a single continuous piece of material as a unitary structural component, the integral element including the substrate, the ground plane with the cavity, and the antenna assembly.

8. The antenna device of claim 1, wherein the antenna assembly comprises a first conductive dipole arm in planar alignment with a surface of the ground plane, a second conductive dipole arm in planar alignment with the surface of the ground plane and adjacent to the first conductive dipole arm, a first feedline in electrical communication with the electronic circuit, and a second feedline in electrical communication with the electronic circuit.

9. An antenna device comprising:
an integral element additively manufactured into a single continuous piece of material as a unitary structural component, the integral element including
a substrate;
a ground plane located adjacent to the substrate, the ground plane having a cavity at least partially adjacent to the substrate; and
an antenna assembly located adjacent to the ground plane; and
an electronic circuit collocated in the cavity and between the ground plane and the substrate.

10. The antenna device of claim 9, further comprising at least one channel extending through the ground plane from the antenna assembly to the substrate.

11. The antenna device of claim 10, wherein the integral element includes at least one feed line extending through the at least one channel from the antenna assembly to the substrate.

12. The antenna device of claim 11, wherein the integral element includes a first pad on the substrate, a second pad on the substrate, and a conductive trace electrically coupled to the first pad and the second pad.

13. The antenna device of claim 12, wherein the at least one feed line is electrically coupled to the first pad and the electronic circuit is electrically coupled to the second pad.

14. The antenna device of claim 9, wherein the antenna assembly includes one of a dipole antenna, a Vivaldi antenna, an inverted hat antenna, a patch antenna, and a monopole antenna.

15. A method of fabricating an antenna device, the method comprising:
providing an integral element additively manufactured into a single continuous piece of material as a unitary structural component, the integral element including
a substrate;
a ground plane located adjacent to the substrate, the ground plane having a cavity at least partially adjacent to the substrate; and
an antenna assembly located adjacent to the ground plane; and
providing an electronic circuit collocated in the cavity and between the ground plane and the substrate.

16. The method of claim 15, further comprising providing at least one channel extending through the ground plane from the antenna assembly to the substrate.

17. The method of claim 16, further comprising providing at least one feed line extending through the at least one channel from the antenna assembly to the substrate.

18. The method of claim 17, further comprising providing a first pad on the substrate, a second pad on the substrate, and a conductive trace electrically coupled to the first pad and the second pad.

19. The method of claim 18, wherein the at least one feed line is electrically coupled to the first pad and the electronic circuit is electrically coupled to the second pad.

20. The method of claim 15, wherein the antenna assembly includes one of a dipole antenna, a Vivaldi antenna, an inverted hat antenna, a patch antenna, and a monopole antenna.
